(19) United States
(12) Patent Application Publication
(10) Pub. No.: US 2010/0176945 A1
(43) Pub. Date: Jul. 15, 2010

(54) DETACHABLE CARRIAGE FOR MERCHANDISE SECURITY SYSTEM

(75) Inventors: Christopher J. Fawcett, Charlotte, NC (US); Larry K. Hooks, JR., Fort Mill, SC (US)

Correspondence Address: Christopher C. Dremann, P.C., 15015 Lancaster Highway, Charlotte, NC, 28277, US

(73) Assignee: INVUE SECURITY PRODUCTS INC., Charlotte, NC (US)

(21) Appl. No.: 12/687,370

(22) Filed: Jan. 14, 2010

Related U.S. Application Data
(60) Provisional application No. 61/144,632, filed on Jan. 14, 2009.

(51) Int. Cl. G08B 13/14

(52) U.S. Cl. 340/568.1

(57) ABSTRACT

A sensor for a merchandise security system for displaying an article of merchandise includes a sensor housing, a detachable carriage releasably attached to the sensor housing, and an alarm for indicating when the article of merchandise is displaced from the detachable carriage or when the detachable carriage is detached from the sensor housing. The detachable carriage includes a carrier having a fastener for attaching the article of merchandise to the detachable carriage and a switch that is movable between an extended position and a retracted position when the article of merchandise is attached to the detachable carriage. The sensor housing includes a contact plate for biasing the switch in the extended position and an electrical contact for completing an electrical circuit with the alarm when the detachable carriage is attached to the sensor housing. The carrier is slidable within the detachable carriage for positioning the article of merchandise relative to the sensor housing.

### CROSS REFERENCE TO RELATED APPLICATION

This non-provisional application claims the benefit of priority of U.S. Provisional Patent Application No. 61/144,632, filed on Jan. 14, 2009, the disclosure of which is incorporated herein by reference in its entirety.

### BACKGROUND OF THE INVENTION

This invention relates generally to merchandise security systems for displaying an article of merchandise, while deterring theft and preventing removal of the merchandise from a display area by an unauthorized person. More particularly, the invention relates to a detachable carriage for a sensor removably disposed on a display stand of a merchandise security system.

It is common practice for retailers to display articles of merchandise, such as relatively small, relatively expensive consumer electronics products, in a display area of a retail store on a display stand of a merchandise security system. The display stand allows a potential purchaser to closely examine and operate an article of merchandise prior to purchasing the item. At the same time, the merchandise security system deters theft or removal of the article of merchandise from the display area by an unauthorized person. The use of a merchandise security system including a display stand also improves sales efficiency and reduces labor costs by permitting a potential purchaser to examine and operate a sample of the merchandise regardless of the availability of a salesperson. The relatively small size and expense of the consumer electronics products, however, increases the likelihood that the article of merchandise will be stolen or removed from the display area by an unauthorized person.

A known disadvantage of conventional merchandise security systems is that the merchandise must be fastened with some type of mechanical fastener or adhesive to a sensor removably disposed on the display stand. However, the use of a mechanical fastener does not prevent an unauthorized person with a suitable tool from removing the fastener, while the use of an adhesive does not prevent an unauthorized person from prying the merchandise off the sensor by overcoming the strength of the adhesive. As a means of combating this problem, most merchandise security systems locate the mechanical fastener on the sensor in a location that is inaccessible or out of view of potential thieves and unauthorized persons. Unfortunately, the inaccessible or concealed location also makes it more difficult for store personnel to remove the merchandise from the sensor. As a result, replacing the article of merchandise or exchanging the article of merchandise with a different article of merchandise s both cumbersome and time consuming. In certain instances, store personnel must first disarm and then disassemble the merchandise security system in order to replace or exchange the article of merchandise.

Accordingly, there exists a need for an improved merchandise security system for displaying an article of merchandise, while deterring theft and preventing removal of the merchandise from a display area by an unauthorized person. There exists a specific need for a detachable carriage for a sensor of a merchandise security system that permits store personnel to readily remove an article of merchandise for replacement or exchange without having to disarm and disassemble the merchandise security system.

### BRIEF SUMMARY OF THE INVENTION

The aforementioned needs, objectives and advantages, as well as others that will be readily apparent to those skilled in the art, are provided by an improved merchandise security system for displaying an article of merchandise, while deterring theft and preventing removal of the merchandise from a display area by an unauthorized person. In various embodiments, the improved merchandise security system includes a sensor having a sensor housing and a detachable carriage that is releasably attached to the sensor housing.

In one aspect, the present invention provides a merchandise security system for displaying an article of merchandise. The merchandise security system includes a display stand and a sensor removably disposed on the display stand. The sensor includes a sensor housing and a detachable carriage releasably attached to the sensor housing. The detachable carriage has a fastener for attaching the article of merchandise to the detachable carriage. The sensor further includes an alarm for indicating when the article of merchandise is displaced (separated) from the detachable carriage or when the detachable carriage is detached from the sensor housing.

In an exemplary embodiment, the detachable carriage includes a top cover, a carrier tray and a carrier movably disposed between the top cover and the carrier tray. The carrier houses the fastener and is configured for slidably moving the fastener in a lengthwise direction relative to the sensor housing.

In another exemplary embodiment, the merchandise security system further includes an actuator assembly for engaging a movable coupling flange. The coupling flange has a hook portion that engages the detachable carriage in a first position to attach the detachable carriage to the sensor housing. The hook portion is out of engagement with the detachable carriage in a second position to release the detachable carriage from the sensor housing and thereby permit the detachable carriage to be detached from the sensor housing.

### BRIEF DESCRIPTION OF THE DRAWINGS

The present invention is best understood by reference to the following detailed description when taken in conjunction with the accompanying drawing figures.

FIG. 1 is a perspective view of an exemplary embodiment of a merchandise security system for displaying an article of merchandise including a detachable carriage in accordance with the invention with the article of merchandise shown in broken lines for purposes of clarity.

FIG. 2 is a front view of the merchandise security system of FIG. 1 with the article of merchandise shown in broken lines for purposes of clarity.

FIG. 3 is a perspective view of the sensor of the merchandise security system of FIG. 1 shown with the article of merchandise removed for purposes of clarity.

FIG. 4 is an exploded perspective view of the sensor of FIG. 3.

FIG. 5 is a perspective view of the interior components of the sensor of FIG. 3 with the detachable carriage and the sensor housing shown in broken lines for purposes of clarity.

FIG. 6 is a side view of the sensor of FIG. 5 shown with an article of merchandise attached to the detachable carriage in a first secured position.

FIG. 7 is a side view of the sensor of FIG. 5 shown with the article of merchandise displaced (separated) from the detachable carriage to a second unsecured position.

FIG. 8 is a detailed perspective view of a coupling assembly of the sensor of FIG. 5 shown with the coupling assembly and the detachable carriage in a coupled configuration.

FIG. 9 is a detailed perspective view of the coupling assembly of the sensor of FIG. 5 shown with the coupling assembly and the detachable carriage shown in an uncoupled configuration.

FIG. 10 is a sectional view illustrating the coupling assembly of the sensor of FIG. 5 in the coupled configuration with the detachable carriage detached from the sensor housing.

FIG. 11 is a sectional view illustrating the coupling assembly of the sensor of FIG. 5 and the detachable carriage shown in a partially coupled configuration.

FIG. 12 is a sectional view illustrating the coupling assembly of the sensor of FIG. 5 and the detachable carriage shown in a completely coupled configuration.

FIG. 13 is a sectional view illustrating the coupling assembly of the sensor of FIG. 5 engaged by a special tool with the coupling assembly and the detachable carriage shown in a partially uncoupled configuration.

FIG. 14 is a sectional view illustrating the coupling assembly of the sensor of FIG. 5 engaged by a special tool with the coupling assembly and the detachable carriage shown in a completely uncoupled configuration.

### DETAILED DESCRIPTION OF THE INVENTION

Referring now to the accompanying drawing figures wherein identical reference numerals denote like or similar elements throughout the various views, a merchandise security system, indicated generally at 10, according to the present invention is shown. The security system 10 is operable for displaying an article of merchandise, such as a relatively small, relatively expensive consumer electronics product (e.g. mobile telephone, digital camera, digital music player, etc.) indicated generally at 41, on a display stand 20. The security system 10 is suitable for use in a display area of a retail store to permit a potential purchaser to closely examine and operate the article of merchandise 41, while deterring theft and preventing removal of the article of merchandise from the display area by an unauthorized person.

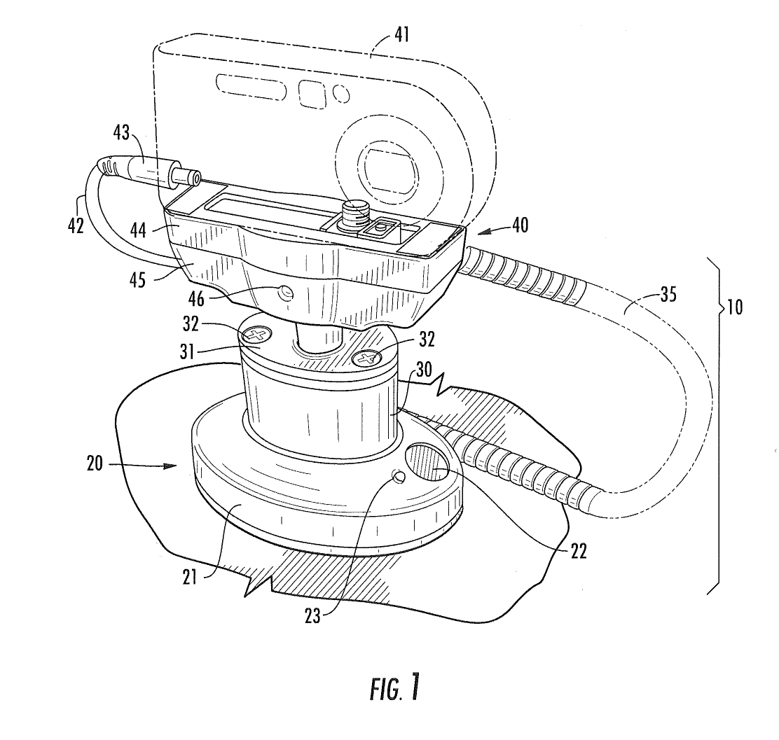

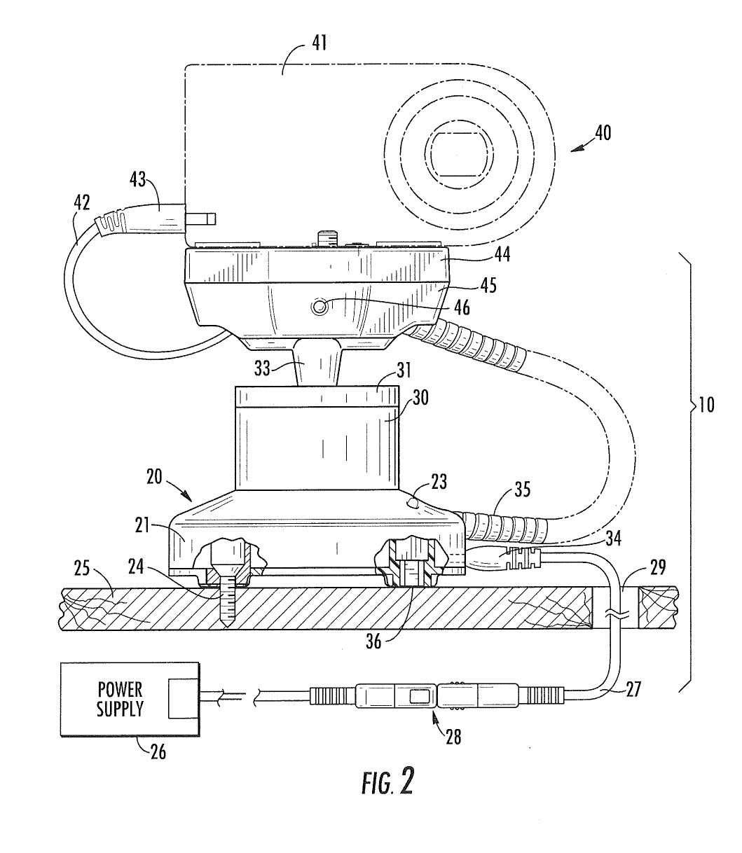

As shown and described herein, and particularly as shown in FIG. 1 and FIG. 2, the security system 10 comprises a sensor 40 removably disposed on the display stand 20. The sensor 40 includes a detachable carriage 44 having means for attaching the article of merchandise 41 to the detachable carriage and the merchandise security system 10. The detachable carriage 44 is configured to be releasably attached to a sensor housing 45 of the sensor 40. As will be described in greater detail hereafter, the sensor 40 includes a contact, limit or proximity switch 49 for indicating when the article of merchandise 41 is displaced from a first secured position on the detachable carriage 44 of the sensor to a second unsecured position, or when the detachable carriage is detached from the sensor housing 45. The sensor 40 is removably disposed on the display stand 20 by a post 33 (FIG. 2) that depends downwardly from the sensor housing 45. In alternative embodiments, the post 33 may be configured to permit rotational movement of the sensor 40 relative to the display stand 20, or may be configured for rigid placement of the sensor on the display stand. If desired, the post 33 may be self-aligning by means of, for example, a mechanical alignment or a magnetic attraction alignment, in order to orient the sensor 40, and consequently the article of merchandise 41, relative to the display stand 20 in a predetermined desirable orientation.

The display stand 20 includes a base 21 for securing the display stand as shown with at least one fastener 24 to a rigid support 25, such as a shelf, desk, counter or tabletop. Alternatively, the display stand 20 may be attached to the support 25 by an adhesive or other non-destructive means, such as a magnetically attractable plate fixed to the underside of the display stand. The display stand 20 further includes a pedestal 30 for receiving the post 33 of the sensor 40 within an opening formed in a cover 31. The cover 31 is provided to close the top of the pedestal 30 and may be affixed to the pedestal by a plurality of fasteners 32, or by other suitable means. An arming port 22 positioned on the base 21 (as shown in FIG. 1) or the pedestal 30 is in wireless communication with a logic control circuit on a microprocessor or central controller (n of shown) disposed within the display stand 20. The arming port 22 is configured to receive an operating signal, for example an infrared (IR), a radio frequency (RF), or an electromagnetic or magnetic pulse generated by an energy source, for example a programmable key operated by an authorized person. The arming port 22 receives the operating signal and transmits the operating signal to the central controller initially to program, and then subsequently to arm and disarm the merchandise security system 10 in a known manner.

A programmable alarm module suitable for use with the merchandise security system 10 is shown and described in the commonly owned U.S. patent application Ser. No. 11/638,727 filed Dec. 14, 2006, and entitled “PROGRAMMABLE ALARM MODULE AND SYSTEM FOR PROTECTING MERCHANDISE,” the disclosure of which is incorporated herein by reference in its entirety. A programmable key (not shown) suitable for use with the merchandise security system 10 is shown and described in the commonly owned U.S. patent application Ser. No. 11/639,100 filed Dec. 14, 2006, and entitled “PROGRAMMABLE KEY FOR A SECURITY SYSTEM FOR PROTECTING MERCHANDISE,” the disclosure of which is incorporated herein by reference in its entirety. A visible indicator 23, such as a light-emitting-diode (LED) is provided on the base 21 or the pedestal 30 of the display stand 20 to indicate the “armed” or “disarmed” state of the merchandise security system 10. As will be described in greater detail, once a merchandise security system 10 including a detachable carriage 44 in accordance with the invention has been programmed and armed, the merchandise security system need only be disarmed before the detachable carriage can be detached from the sensor housing 45 without activating an audible or visible alarm.

As shown herein, the merchandise security system 10 further comprises an external power supply 26 for supplying electrical power to the display stand 20, the sensor 40 and, if desired, to the article of merchandise 41. An electrical power cable 27 has a connector 34 at one end for attachment to the base 21 of the display stand 20. The power cable 27 extends through an opening 29 formed through the rigid support 25 to a connector 28 at the opposite end for attachment directly to the power supply 26, or as shown herein, to a length of extension cable from the power supply. Alternatively, an internal power source (e.g. battery) may be provided for supplying electrical power to one or more of the components. Regardless, the sensor 40 is electrically connected to the power supply 26 through the display stand 20 by a helical coil cable 35 that extends between the base 21 of the display stand and the sensor housing 45 of the sensor. As a result, the helical coil cable 35 is commonly referred to as the “sensor cable.” If desired, the sensor cable 35 may be connected to the display stand 20 and the sensor housing 45 in a manner (e.g. hard-wired) that prevents the sensor cable from being readily detached from the display stand or the sensor housing. As such, the sensor cable 35 further acts to mechanically secure (i.e. physically retain) the sensor 40, and consequently the article of merchandise 41, to the display stand 20, which in turn is fixed to the rigid support 25 as previously described.

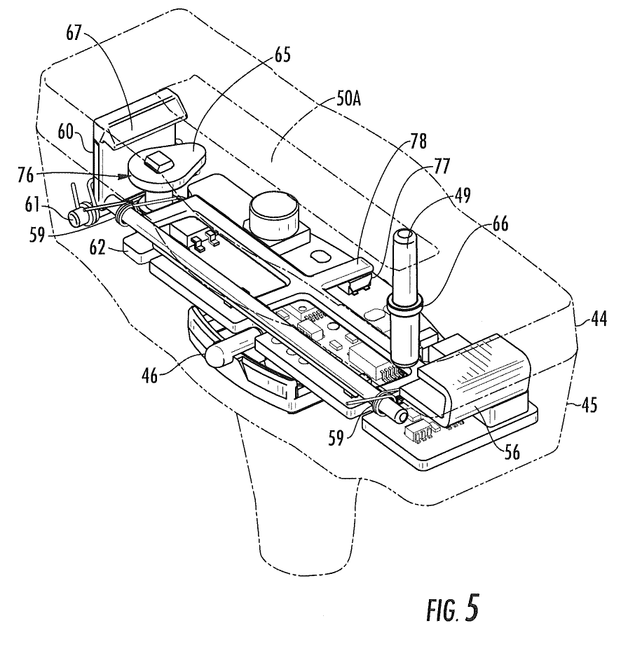

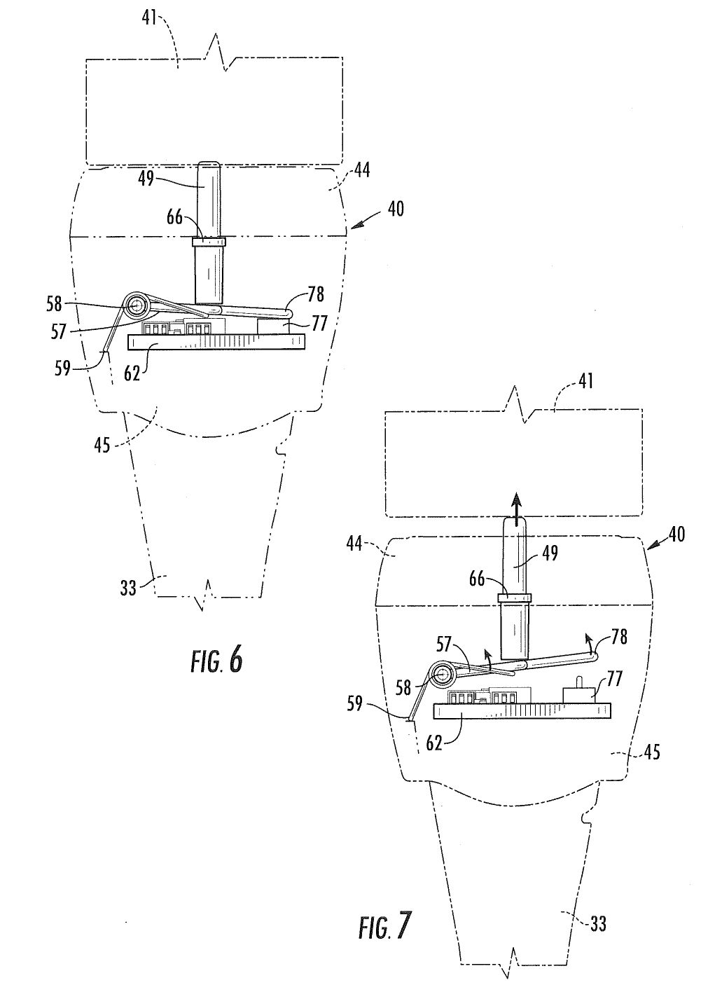

An alarm (not shown) located below the rigid support 25 or disposed within the display stand 20 produces an audible and/or visible alarm signal when the article of merchandise 41 is displaced, as will be described hereinafter with reference to FIG. 6 and FIG. 7, from a first secured position on the detachable carriage 44 to a second unsecured position. The alarm is likewise activated to produce the alarm signal in the event that electrical power from the power supply 26 is interrupted, or in the event that electrical power between the display stand 20 and the sensor housing 45 is interrupted. An interruption of electrical power may occur, for example, if the power cable 27 is disconnected or severed, or if the sensor cable 35 is disconnected or severed. The alarm may also be activated to produce the alarm signal in the event that a contact, limit or proximity switch 36 (FIG. 2) disposed between the base 21 of the display stand 20 and the support 25 indicates that the display stand has been displaced from the support. In this manner, the alarm will produce the alarm signal if any type of tampering occurs when the merchandise security system 10 is in the armed configuration.

The sensor 40 may optionally include an electrical cable 42, commonly referred to as “an adapter cable or pigtail,” that is attached at one end to the sensor housing 45 and has a connector 43 at the other end for attachment to the article of merchandise 41. Cable 42 is adapted to provide electrical power at an appropriate voltage to the article of merchandise 41 and/or maintain a constant electrical charge on a battery or power pack for powering the article of merchandise. In this manner, potential purchasers may repeatedly examine and operate the article of merchandise 41 in a powered state. The display stand 20, and more preferably, the sensor housing 45 may comprise a voltage regulator for adjusting the voltage provided by the power supply 26 to a voltage suitable for use with a particular article of merchandise 41. Furthermore, the cable 42 can be sized and fitted with a connector 43 configured for use with the particular type and brand of article of merchandise 41. Likewise, the display stand 20 or the sensor housing 45 may be sized to accommodate a power supply and/or any additional electronics needed for providing power to the article of merchandise 41.

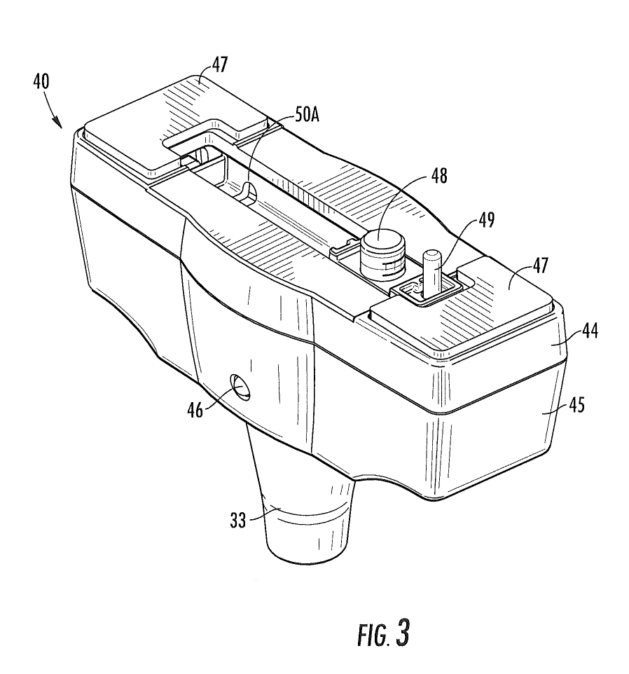

An exemplary embodiment of a sensor 40 having a detachable carriage 44 releasably attached to a sensor housing 45 in accordance with the invention is shown assembled in FIG. 3 and is shown exploded in FIG. 4. The detachable carriage 44 is releasably attached to the sensor housing 45 having the post 33 previously described. An indicator, for example an LED 46, may be provided on the sensor housing 45 for indicating an “armed” or a “disarmed” state of the merchandise security system 10. The detachable carriage 44 has at least one, and preferably a pair of somewhat compliant pads 47 disposed on the outer surface thereof to protect the surface finish on the underside of the article of merchandise 41. The pads 47 also serve to securely grip the article of merchandise 41 at opposite ends of the detachable carriage 44 when an anchor fastener 48 is tightened, as will be described, and thereby prevents an unauthorized person from rotating the article of merchandise 41 to separate the article of merchandise from the detachable carriage.

The detachable carriage 44 defines an open channel 50A extending in a lengthwise direction along an upper surface thereof. The channel 50A is sized and shaped to receive a movable carrier 51, best shown in FIG. 4, configured for rotatably retaining fastener 48. As shown, fastener 48 is externally threaded and is received within an internally threaded recess, for example a tripod mounting hole formed in a conventional camera or video recorder, to secure the article of merchandise 41 to the detachable carriage 44. Carrier 51 is adapted to slide in the lengthwise direction within channel 50A in order to locate the fastener 48 in an appropriate position to engage the recess formed in the article of merchandise 41. The carrier 51 is movable, and in particular is slidable, within the channel 50A so as to allow articles of merchandise 41 having different sizes, for example different lengths, to be positioned on the detachable carriage 44 at a desirable location. For example, it may be desired to center the article of merchandise 41 relative to the detachable carriage 44 and/or the display stand 20. The carrier 51 may also be removable and replaceable so that a suitably sized fastener 48 may be utilized with another article of merchandise 41 having a different type of recess. A conventional contact, limit or proximity switch 49 is also movably mounted on the carrier 51 for a purpose to be described. Switch 49 extends and retracts relative to carrier 51, and thus relative to the detachable carriage 44, in a known manner. Preferably, the switch 49 is “opened” when in the extended position and is “closed” when in the retracted position. Preferably, switch 49 is biased towards the opened position in normal operation. A switch 49 suitable for use with the detachable carriage 44 is shown and described in the commonly owned U.S. patent application Ser. No. 11/638,727, filed Dec. 14, 2006, and entitled “PROGRAMMABLE ALARM MODULE AND SYSTEM FOR PROTECTING MERCHANDISE,” the disclosure of which is incorporated herein by reference in its entirety. Switch 49 is configured to automatically move to the retracted (closed) position as the fastener 48 engages the internally-threaded recess formed in the article of merchandise 41. Conversely, switch 49 automatically moves from the retracted (closed) position to the extended (open) position when the article of merchandise 41 is displaced (i.e. separated) from the detachable carriage 44, for example by loosening or removing the fastener 48.

As best shown in the exploded view of FIG. 4, the detachable carriage 44 comprises a top cover 52 and a carrier tray 53. The top cover 52 and the carrier tray 53 are joined together to define a cavity with the carrier 51 disposed therebetween. The carrier 51 is movably mounted within the cavity, and more particularly, is slidable along rails 69 formed on the interior of the carrier tray 53. A bottom cover 54 is provided on the sensor housing 45 and configured to receive the carrier tray 53 of the detachable carriage 44. The carrier tray 53 is positionable on the sensor housing 45 of the sensor 40 such that the detachable carriage 44 is detachable from the sensor housing, as will be described. The top cover 52, the carrier tray 53 and the bottom cover 54 each define respective, generally aligned channels 50A, 50B, and 50C that are sized and shaped to permit the switch 49 to extend vertically upwards through the channels 50A and 50B of the detachable carriage 44 in the direction of the article of merchandise 41, and vertically downwards through the channel 50C of the bottom cover in the direction of the sensor housing 45. A shoulder 66 is formed on a medial portion of the switch 49 to limit vertical movement of the switch 49 relative to the carrier 51, and thus, relative to the detachable carriage 44.

A U-shaped securing clip 56 retains the bottom cover 54 within the sensor housing 45 and receives one end of the carrier tray 53 of the detachable carriage 44. A contact plate 57 is disposed within the sensor housing 45 of the sensor 40 beneath the bottom cover 54. The contact plate 57 is configured for providing contact between switch 49 and an electrical contact 77 provided on a Printed Circuit Board (PCB) 62 likewise disposed within the sensor housing 45 of the sensor 40. The contact plate 57 includes lengthwise extending shoulders 58 on opposed ends for providing a hinge joint such that the contact plate pivots relative to the sensor housing 45 of the sensor 40, as will be described. The contact plate 57 further includes a lengthwise extending contact arm 75 and a laterally extending contact fork 78 disposed medially along the contact arm 75. The contact arm 75 is generally aligned with switch 49 within channels 50A, 50B, and 50C of top cover 52, carrier tray 53 and bottom cover 54, respectively. In this manner, switch 49 remains in contact with a portion of the contact arm 75 when detachable carriage 44 is attached to the sensor housing 45 regardless of the position of carrier 51 slidably disposed within the detachable carriage between the top cover 52 and the carrier tray 53. Contact plate 57 is biased upwardly towards the detachable carriage 44 by a lengthwise extending torsional spring 59 that engages shoulders 58 at each of the opposed ends of the contact plate.

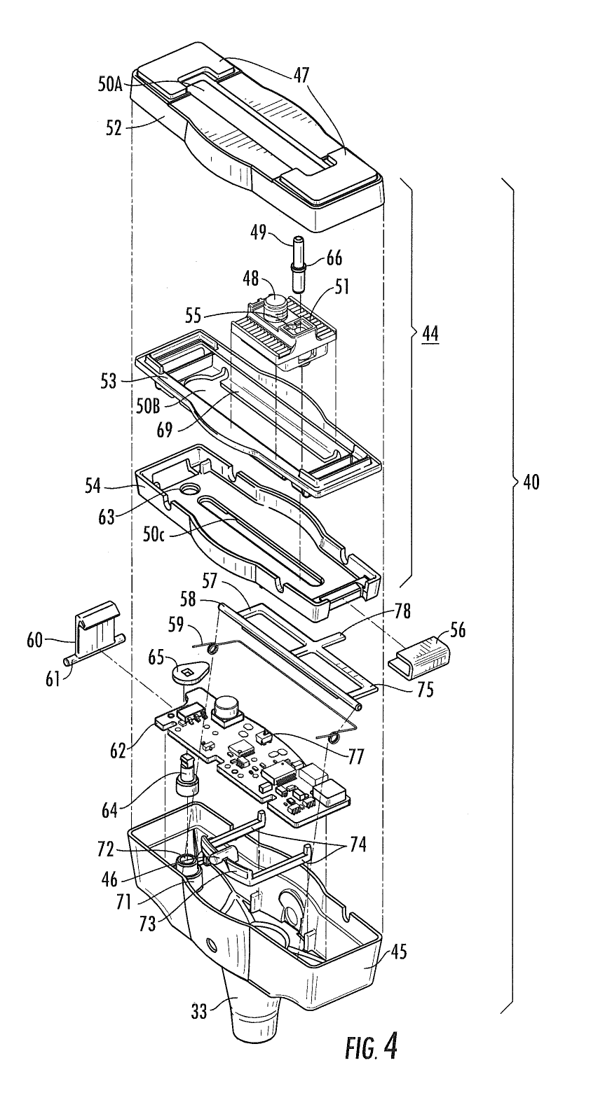

The sensor housing 45 of sensor 40 defines a generally hollow cavity for receiving and housing PCB 62 and the plurality of electrical components disposed thereon. The LED 46 is carried by a support member 73 having a pair of laterally-extending arms 74 that span substantially the entire width of the sensor housing 45 of the sensor 40. The sensor housing 45 also defines a shoulder 71 that receives a journal bearing 72 adapted to engage a journal shaft 64. The journal shaft 64 in turn is fixed to a generally tear-shaped cam 65. Collectively, the journal bearing 72, the journal shaft 64 and the cam 65 form an actuator assembly 76 (FIG. 5), which is shown in greater detail in FIGS. 8-14. A coupling flange 60 is likewise disposed within the cavity defined by the sensor housing 45 of the sensor 40. The coupling flange 60 is biased inwardly by a torsion spring 70 (best shown in FIGS. 8-9 and the operation of which is illustrated in 10-14) that is disposed on a laterally-extending shoulder 61 at the base of the coupling flange 60. As such, the shoulder 61 defines a hinge line about which the torsion spring 70 biases the coupling flange 60 against a mechanical stop in the direction of the PCB 62. The bottom cover 54 has an aperture 63 formed therethrough for providing clearance for journal shaft 64. Coupling flange 60 further comprises a laterally-extending hook portion 67 (FIG. 5) that is sized and shaped so as to engage a complimentary shelf 68 (see FIGS. 12-14) provided on the carrier tray 53 when the detachable carriage 44 is inserted into the sensor housing 45. Hook portion 67 is tapered inwardly so as to assist rotation of the coupling flange 60 about the hinge line 61 as the detachable carriage 44 is inserted into the sensor housing 45 of the sensor 40.

Operation of the merchandise security system 10 is best illustrated in the sequence of views depicted in FIGS. 6-7, FIGS. 8-9 and FIGS. 10-14. In FIG. 6, the article of merchandise 41 is secured to the detachable carriage 44 of the sensor 40 by anchor fastener 48 (not visible) such that the switch 49 is depressed. As a result, the contact fork 78 of the contact plate 57 engages the electrical contact 77 against the biasing force of the torsional spring 59. In FIG. 7, the article of merchandise 41 is displaced somewhat from the detachable carriage 44 of the sensor 40, for example by forcibly overcoming the retaining strength between the externally-threaded fastener and the internally-threaded recess of the article of merchandise. As a result, the contact fork 78 of the contact plate 57 disengages from the electrical contact 77 under the biasing force of the torsional spring 59. As shown herein, torsional spring 59 biases the contact plate 57 about the shoulders 58 in a counter-clockwise direction indicated in FIG. 7 by the smaller-sized arrows. At the same time, the contact arm 75 of the contact plate 57 forces the switch 49 upwardly, thereby causing vertical movement of the switch 49 relative to the carrier 51 and the detachable carriage 44 of the sensor 40. The biasing force normally exerted by torsional spring 59 is sufficient to extend switch 49 when the article of merchandise 41 is displaced (separated) relative to the detachable carriage 44 of the sensor 40, but is not sufficient to overcome the retaining force of the fastener 48. Accordingly, the electrical contact 77 remains engaged by the contact fork 78 of the contact plate 57 in the display configuration illustrated by FIG. 6. However, once switch 49 begins to extend upwardly, the contact fork 78 no longer maintains contact with electrical contact 77. As a result, electrical contact 77 produces an open-circuit condition on PCB 62, which in turn activates an audible or visible alarm signal to alert store personnel that the article of merchandise 41 may have been stolen or may have been removed from the display area by an unauthorized person.

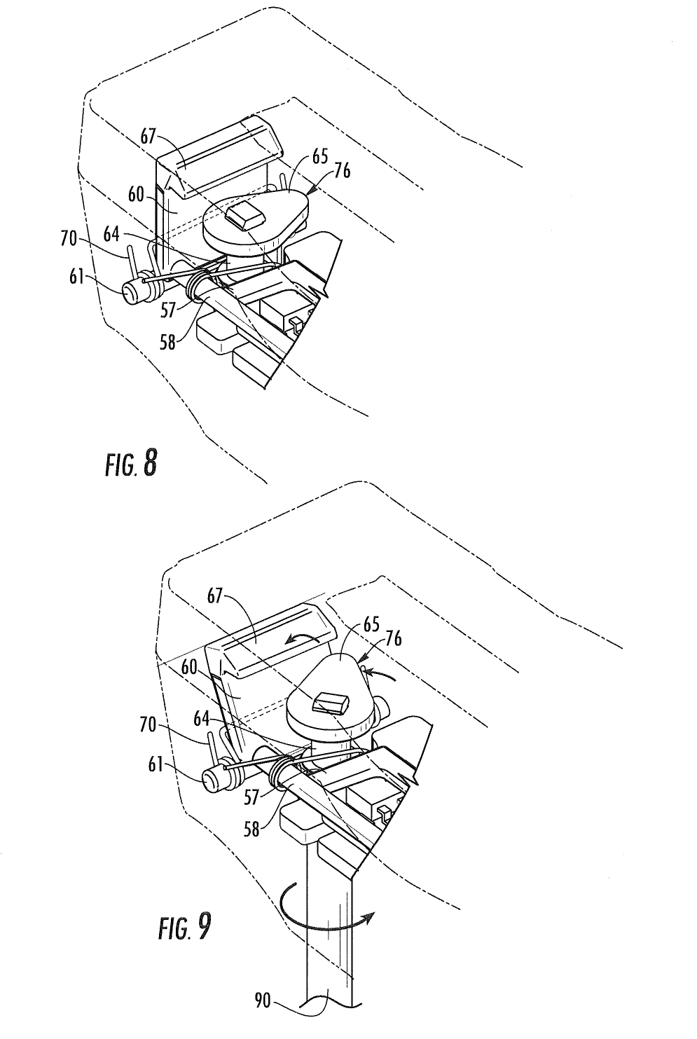

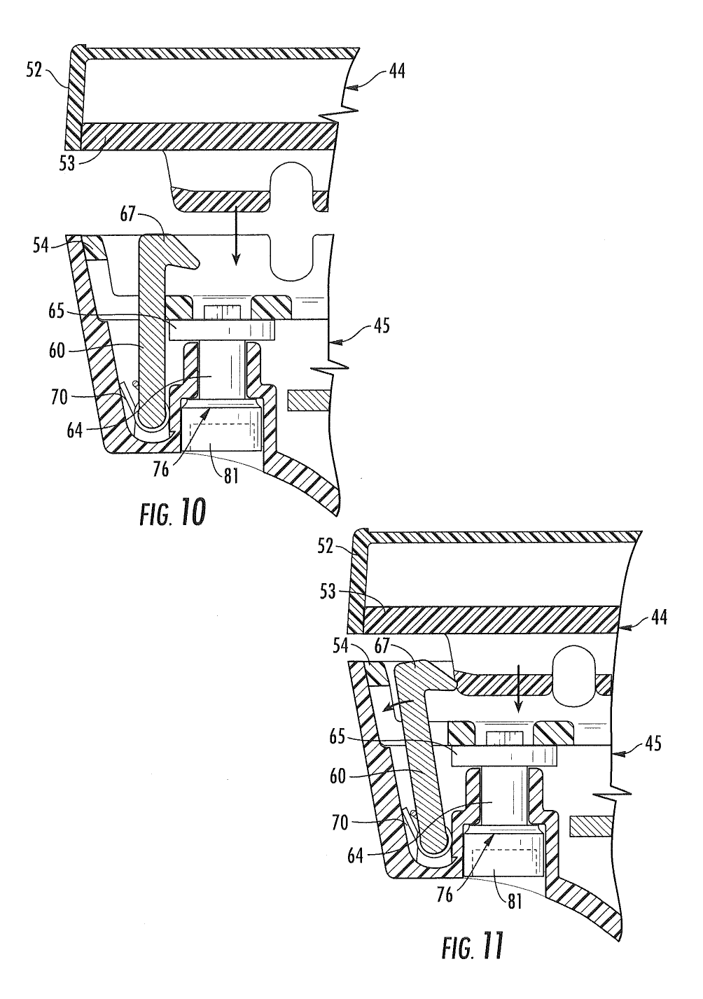

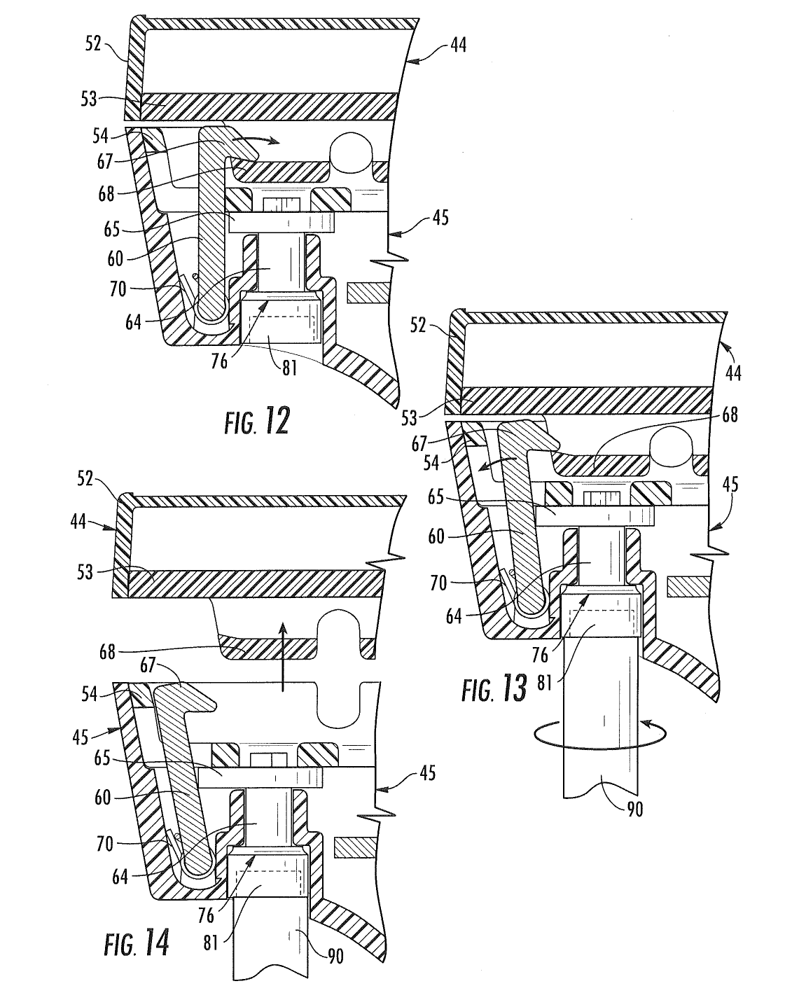

As illustrated in FIGS. 8 and 9, the actuator assembly 76 is adapted for rotational movement about a vertical axis relative to the coupling flange 60. A special tool 90 is provided for insertion into and mechanical engagement with the underside 81 (FIG. 11) of the journal shaft 64. As shown in FIG. 9, the tool 90 is inserted into the journal shaft 64 and subsequently turned in a counter-clockwise direction to rotate cam 65 towards coupling flange 60. Cam 65 is eccentrically shaped so as to engage coupling flange 60 along a cam surface and incrementally rotate the coupling flange about the hinge line 61 by gradually causing the coupling flange 60 to rotate counter-clockwise against the biasing force of torsional spring 70. As a result, the hook portion 67 moves out of engagement with the shelf 68 provided on the carrier tray 53 of the detachable carriage 44. Once the coupling flange 60 is rotated outwardly by the actuator assembly 76, the shelf 68 is no longer obstructed by the hook portion 67 and the detachable carriage 44 can be removed from the sensor housing 45 of the sensor 40. The special tool 90 is intended to be made available only to store personnel and other authorized persons for the purpose of readily removing the detachable carriage 44 to quickly and easily replace the article of merchandise 41 with another article of merchandise to be displayed on the display stand 20. For this reason, the tool 90 may be provided with a uniquely-shaped engagement portion that is complimentary with the underside 81 of the journal shaft 64. As will be readily apparent to those skilled in the art, removing detachable carriage 44 will disengage switch 49 from contact plate 57 in sensor housing 45 of sensor 40 in the manner previously described, thereby causing the PCB 62 to activate the audible or visible alarm signal. Accordingly, the alarm should be deactivated (i.e. disarmed) prior to removing detachable carriage 44 from the sensor housing 45 of the sensor 40. The appropriate operating steps including inserting detachable carriage 44 into sensor housing 45 and engaging the hook portion 67 of coupling flange 60 with shelf 68 of carrier tray 53 to secure the detachable carriage on the sensor housing are illustrated in FIGS. 10-12. The appropriate operating steps including inserting tool 90 into the underside 81 of the journal shaft 64 and engaging the cam 65 of the actuator assembly 76 with the coupling flange 60 to remove the detachable carriage 44 from the sensor housing 45 of the sensor 40 are illustrated in FIGS. 13-14.

As previously mentioned, a feature of a merchandise security system 10 in accordance with the invention is that the article of merchandise 41 and the detachable carriage 44 cannot be detached from the sensor housing 45 of the sensor 40 without causing the audible or visible alarm signal to be activated unless the alarm signal is first disarmed through arming port 22. The logic control circuit of the microprocessor or central controller may be configured to provide a predetermined amount of time for removal and replacement of the detachable carriage 44. Alternatively, the logic control circuit of the microprocessor or central controller may be configured to require the merchandise security system 10 to be disarmed through the arming port 22 by an energy source from a programmable key in cases where the logic control circuit and the programmable key have each been programmed with the same security disarm code (SDC). Once the alarm signal of the merchandise security system 10 has been disarmed, the special tool 90 can be inserted into the journal shaft 64 of the actuator assembly 76 to move the coupling flange 60 out of engagement with shelf 68 of carrier 51. The detachable carriage 44 can then be lifted upwards relative to the sensor housing 45 of the sensor 40 and removed. Access to the fastener 48 is provided from the underside of the carrier 51 of the detachable carriage 44 so that an authorized person may remove and replace the article of merchandise 41 prior to re-attaching the detachable carriage onto the sensor housing 45 of the sensor 40. Alternatively, the entire detachable carriage 44 may be quickly and easily replaced with a substitute detachable carriage having a different article of merchandise attached thereto.

It will be readily apparent to those skilled in the art that a merchandise security system 10 according to the invention may be provided with a sensor 40 including a sensor housing 45 and a detachable carriage 44 releasably attached to the sensor housing. The detachable carriage 44 may include a carrier 51 movably disposed within the detachable carriage and having a fastener 48 for attaching an article of merchandise 41 to the detachable carriage. The detachable carriage 44 may be configured to be detached from the sensor housing 45 of the sensor 40 so that the article of merchandise 41 can be readily removed and replaced without having to disassemble the merchandise security system 10. The merchandise security system 10 may be configured such that the detachable carriage 44 is releasable once an alarm signal has been disarmed when a special tool 90 is utilized to disengage a coupling flange 60 disposed within the sensor housing 45 of the sensor 40. In this manner, the detachable carriage 44 and the article of merchandise 41 may be easily and quickly removed from a sensor 40 that is removably disposed on a display stand 20 configured for displaying the article of merchandise in a display area of a retail store.

The foregoing has described exemplary embodiments of a merchandise security system for displaying an article of merchandise, while deterring theft and preventing removal of the article of merchandise from a display area by an unauthorized person. In the exemplary embodiments shown and described herein, the merchandise security system includes a display stand and a sensor removably disposed on the display stand wherein the sensor includes a sensor housing and a detachable carriage releasably attached to the sensor housing and configured for attachment to the article of merchandise. While exemplary embodiments of the present invention have been described, it will be apparent to those skilled in the art that various modifications thereto can be made without departing from the spirit and scope of the invention. Accordingly, the description of preferred embodiments of the invention and the best mode for practicing the invention are provided herein for the purpose of illustration only, and not for the purpose of limitation. In particular, it will be appreciated that a merchandise security system including a sensor having a sensor housing and a detachable carriage may be applicable for use with various other items or things, and with or without an audible or visible alarm for indicating that the article of merchandise is displaced from the detachable carriage or that the detachable carriage is detached from the sensor housing.

That which is claimed is:

1. A sensor for a merchandise security system, comprising
a sensor housing;
a detachable carriage releasably attached to the sensor housing, the detachable carriage configured for attaching an article of merchandise to the detachable carriage; and
an alarm for indicating when the article of merchandise is displaced from the detachable carriage or when the detachable carriage is detached from the sensor housing.

2. The sensor of claim 1, wherein the detachable carriage comprises a fop cover, a carrier tray and a carrier movably disposed between the top cover and the carrier tray.

3. The sensor of claim 2, wherein the carrier has a fastener for attaching the article of merchandise to the detachable carriage and wherein the carrier is slidably movable for positioning the article of merchandise relative to the sensor housing.

4. The sensor of claim 3, wherein the carrier is configured for slidably moving the fastener in a lengthwise direction relative to the sensor housing.

5. The sensor of claim 1, wherein the alarm is activated to provide an audible or visible alarm signal.

6. The sensor of claim 1, wherein the sensor housing comprises an actuator assembly for engaging a movable coupling flange to releasably attach the detachable carriage to the sensor housing.

7. The sensor of claim 6, wherein the coupling flange has a hook portion that engages the detachable carriage in a first position to attach the detachable carriage to the sensor housing and wherein the hook portion is out of engagement with the detachable carriage in a second position to release the detachable carriage from the sensor housing and thereby permit the detachable carriage to be detached from the sensor housing.

8. The sensor of claim 7, wherein the actuator assembly comprises a rotatable journal shaft having a cam for engaging the coupling flange and wherein the coupling flange is biased in the first position.

9. The sensor of claim 1, wherein the detachable carriage comprises a carrier having a fastener for attaching the article of merchandise to the detachable carrier and a switch movable between an extended position and a retracted position and wherein the sensor housing comprises an electrical contact for completing an electrical circuit with the alarm when the switch is in the retracted position.

10. The sensor of claim 9, wherein the switch is biased in the extended position and is moved to the retracted position when the article of merchandise is attached to the detachable carrier.

11. The sensor of claim 10, wherein the electrical contact completes the electrical circuit when the detachable carriage is attached to the sensor housing.

12. A detachable carriage configured for attachment to an article of merchandise and for releasable attachment to a sensor housing of a sensor, the detachable carriage comprising:
a top cover;
a carrier tray; and
a carrier movably disposed between the top cover and the carrier tray, the carrier having a fastener for attaching the article of merchandise to the detachable carrier and a switch that is movable between an extended position and a retracted position.

13. The detachable carriage of claim 12, wherein the sensor housing biases the switch in the extended position and wherein attaching the article of merchandise to the detachable carriage moves the switch from the extended position to the retracted position.

14. The detachable carriage of claim 12, wherein the carrier is movable in a lengthwise direction for positioning the article of merchandise relative to the sensor housing.

15. The detachable carriage of claim 14, wherein the carrier tray comprises at least one rail supporting and guiding the carrier in the lengthwise direction.

16. A merchandise security system for displaying an article of merchandise, comprising:
a display stand; and
a sensor removably disposed on the display stand, the sensor comprising a sensor housing and a detachable carriage releasably attached to the sensor housing, the detachable carriage comprising a carrier having a fastener for attaching the article of merchandise to the detachable carriage and a switch that is movable between an extended position and a retracted position, the sensor housing comprising a contact plate for biasing the switch in the extended position and an electrical contact for communicating with an alarm when the switch is in the retracted position.

17. The merchandise security system of claim 16, wherein the detachable carriage of the sensor comprises a top cover and a carrier tray and wherein the carrier is slidably disposed between the top cover and the carrier tray for positioning the fastener and the article of merchandise relative to the sensor housing.

18. The merchandise security system of claim 16, wherein the sensor housing comprises a movable coupling flange and an actuator assembly for engaging the coupling flange, the coupling flange movable between a first position for attaching the detachable carriage to the sensor housing and a second position for releasing the detachable carriage from the sensor housing to thereby permit the detachable carriage to be detached from the sensor housing.

19. The merchandise security system of claim 18, wherein the actuator assembly comprises a rotatable journal shaft having a cam for engaging the coupling flange and wherein the coupling flange is biased in the first position.

20. The merchandise security system of claim 16, wherein the alarm is activated when the article of merchandise is displaced from the detachable carriage or when the detachable carriage is detached from the sensor housing.
